(19) United States
(12) Patent Application Publication
(10) Pub. No.: US 2019/0168818 A1
(43) Pub. Date: Jun. 6, 2019

(54) VEHICLE CROSS MEMBERS AND RELATED METHODS

(71) Applicant: SABIC Global Technologies B.V., Bergen op Zoom (NL)

(72) Inventors: Harold van Aken, Schinnen (NL); Sandeep Kulkarni, Geleen (NL); Warden Schijve, Geleen (NL); Bert Rietman, Geleen (NL)

(21) Appl. No.: 16/322,784

(22) PCT Filed: Aug. 3, 2017
(86) PCT No.: PCT/IB2017/054772

§ 371 Date: Feb. 1, 2019

Related U.S. Application Data
(60) Provisional application No. 62/370,497, filed on Aug. 3, 2016.

(51) Int. Cl. B62D 25/14; B62D 29/00; B62D 29/04

(52) U.S. Cl. CPC B62D 25/145; B62D 29/04; B62D 29/005

(57) ABSTRACT

This disclosure includes vehicle cross members and related methods. Some cross members include an elongated beam having a sidewall extending between first and second ends to define a first channel extending along a longitudinal axis of the beam and across at least longitudinally adjacent first and second sections of the beam, the first channel being open on a first side of the beam, and a second channel extending along the longitudinal axis and across at least the second section, the second channel being disposed below the first channel and open on a second side of the beam that is opposite the first side. Some cross members include a composite body having a plastic material and one or more laminates, where the body defines the beam such that at least one of the laminate(s) borders a majority of an inner cross-sectional perimeter of each of the first and second channels.

### CROSS-REFERENCE TO RELATED APPLICATIONS

This application claims the benefit of priority of U.S. Provisional Patent Application No. 62/370,497 filed Aug. 3, 2016, which is hereby incorporated by reference in its entirety.

### BACKGROUND

### 1. Field of Invention

The present invention relates generally to vehicle cross members, and more specifically, but not by way of limitation, to car cross beams and methods for making the same.

### 2. Description of Related Art

Vehicles (e.g., cars, trucks, busses, and/or the like) can include a variety of cross members, such as, for example, car cross beams, pillars (e.g., A-, B-, C-, and/or D-pillars), bumper beams, and door beams, just to name a few. Such cross members may serve various purposes, such as those relating to safety, structural integrity, noise vibration and harshness (NVH) reduction, and/or the like.

To illustrate, many vehicles include a car cross beam for supporting a dash, a steering column, an instrument panel, heating, ventilation, and air conditioning (HVAC) components, airbags, and/or the like. Such a car cross beam may need to be rigid to, for example, resist undesirable movement of supported components (e.g., in the event of a crash), increase the structural integrity of the vehicle body, and/or reduce NVH.

### SUMMARY

Many existing car cross beams are formed, at least in part, of steel and/or other heavy metals. Some existing car cross beams may be at least partially formed from lighter-weight metals, such as magnesium, aluminum, and/or the like. Other existing car cross beams may be formed, at least in part, from light weight composite materials. Many existing car cross beams, regardless of their material(s) of manufacture, are of multi-piece construction, consisting of an assembly of stamped component(s), bracket(s), beam(s), and/or the like.

Such existing car cross beams may be subject to a number of shortcomings. To illustrate, car cross beams including steel and/or other heavy metals may be undesirably heavy, resulting in a decrease in vehicle performance and/or an increase in assembly time and/or cost. Existing car cross beams including lighter-weight metals, such as magnesium, aluminum, and/or the like, may be relatively expensive and may necessitate increased tool maintenance (e.g., due to increased casting temperature requirements). Existing car cross beams including light weight composite materials may necessitate complex, multi-piece construction due to, for example, difficulties associated with the molding process. Existing car cross beams of multi-piece construction may complicate assembly procedures (e.g., by requiring the joining of different materials), and/or undesirably increase weight, assembly time, and/or cost. As described in more detail below, the present vehicle cross members can be configured to address some or all of these shortcomings.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

As used in this disclosure, a “lamina” is a layer of material that is formed by introducing a matrix material into an arrangement of fibers, and “laminae” is the plural form of lamina. A “laminate” is a layer of material including one or more laminae, whether or not consolidated.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes,” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above, and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1A is a front perspective view of a first embodiment of the present vehicle cross members.

FIGS. 1B and 1C are front perspective and rear perspective views, respectively, of the cross member of FIG. 1A.

FIG. 2 is a schematic cross-sectional end view of the cross member of FIG. 1A, taken along line 2-2 of FIG. 1B.

FIGS. 3A-3D are schematic cross-sectional end views of supports and/or beams that may be suitable for use in some embodiments of the present cross members.

FIGS. 4A and 4B are schematic exploded views of laminates that may be suitable for use in some embodiments of the present cross members.

FIG. 5A is a perspective view of a joint that may be suitable for use between adjacent sections of and/or between a plastic material and one or more laminates of some embodiments of the present cross members.

FIG. 5B is a schematic cross-sectional side view of the joint of FIG. 5A, taken along line 5B-5B of FIG. 5A.

FIGS. 6A and 6B are schematic views of ribs for reinforcing the joint of FIG. 5A.

FIG. 7 is a back perspective view of a second embodiment of the present vehicle cross members.

FIG. 8A is a schematic cross-sectional end view of the cross member of FIG. 7, taken along line 8A-8A of FIG. 7.

FIGS. 8B and 8C are schematic cross-sectional end views of supports and/or beams that may be suitable for use in some embodiments of the present cross members.

FIG. 9 is a front perspective view of a third embodiment of the present vehicle cross members.

FIG. 10A is a schematic cross-sectional end view of the cross member of FIG. 9, taken along line 10A-10A of FIG. 9.

FIGS. 10B-10K are schematic cross-sectional end views of supports and/or beams that may be suitable for use in some embodiments of the present cross members.

FIG. 11A is a front perspective view of a fourth embodiment of the present vehicle cross members.

FIG. 11B is a cross-sectional end view of the cross member of FIG. 11A, taken along line 11B-11B of FIG. 11A.

FIGS. 12A and 12B are schematic cross-sectional views a mold that may be suitable for forming a composite body of some embodiments of the present cross members.

FIGS. 13A-13C are schematic cross-sectional views of a mold that may be suitable for forming a composite body of some embodiments of the present cross members.

### DETAILED DESCRIPTION

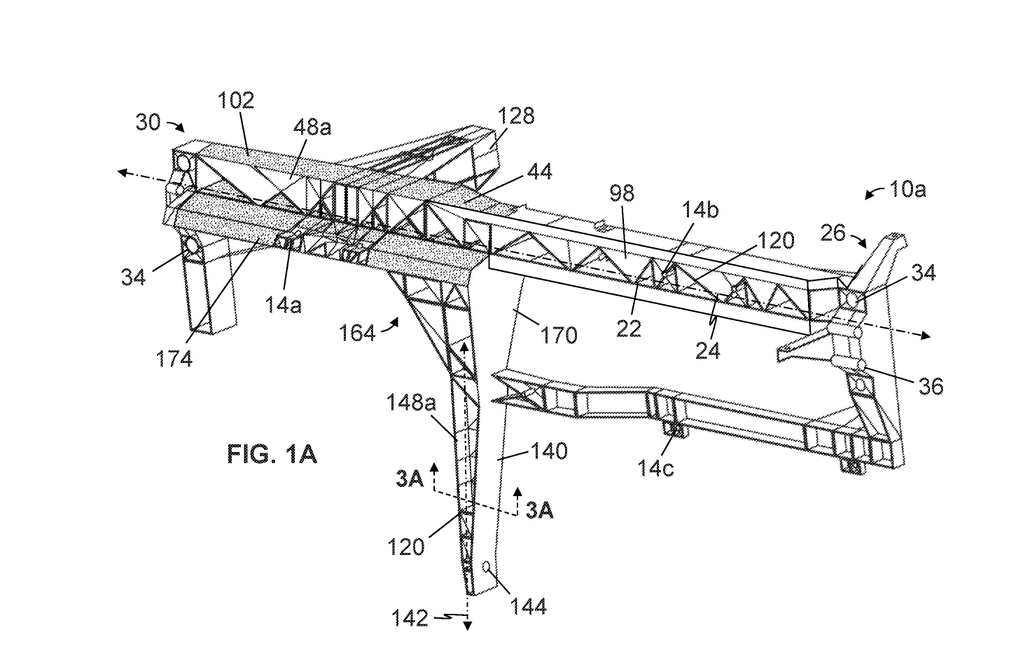

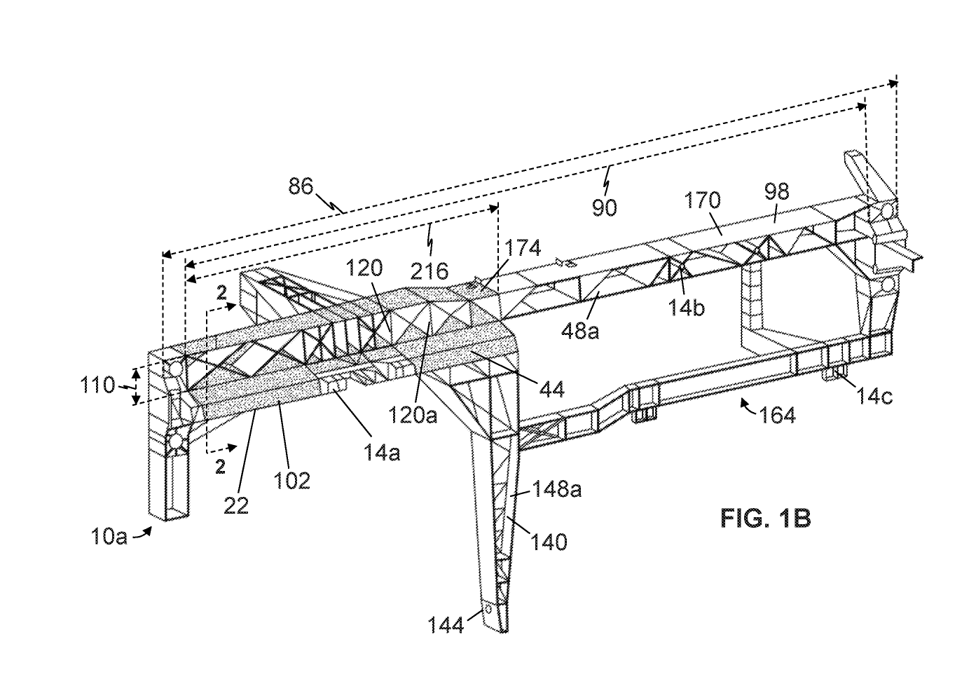

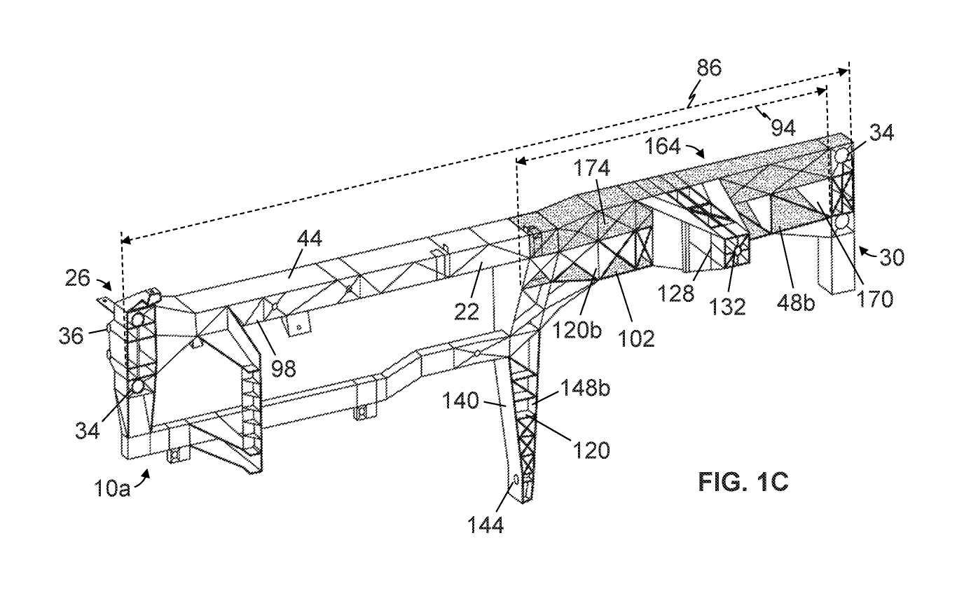

FIGS. 1A-1C depict a first embodiment 10a of the present vehicle cross members. Cross member 10a comprises a car cross beam in that the cross member can be coupled to a vehicle (e.g., car, truck, bus, other vehicle, and/or the like) to provide support for certain vehicle component(s), such as, for example, a dash, steering column, instrument panel, heating, ventilation, and air conditioning (HVAC) component, airbag, and/or the like. For example, cross member 10a can include one or more mounts, each configured to support one or more of various vehicle components; to illustrate, mount 14a can support a steering column and/or instrument cluster, mount 14b can support an airbag housing or carrier, and/or mount 14c can support a heating, ventilation, and air conditioning (HVAC) component. Other vehicle cross members can comprise any suitable cross member, such as, for example, a front bulkhead, rear bulkhead, A-pillar, B-pillar, C-pillar, D-pillar, bumper beam, door beam, or the like.

Cross member 10a can include an elongated beam 22 that extends between a first end 26 and a second end 30 and is configured to be secured to a vehicle, such that, for example, the beam extends transversely across at least a portion of a passenger compartment of the vehicle, serves as a horizontal load bearing portion of the cross member, and/or the like. For example, at least one of first end 26 and second end 30 of beam 22 can define one or more openings 34 (e.g., holes, slots, recesses, and/or the like) for securing the beam to a vehicle, via, for example, receiving one or more fasteners that can be disposed into the vehicle. In at least this way, some cross members (e.g., 10a) can be mounted to a vehicle at one or more locations (e.g., at first end 26 and/or second end 30 of beam 22), without requiring separate mounting component(s) (other than fasteners), such as, for example, flange(s), mount(s), plate(s), and/or the like, which can reduce manufacturing costs, assembly time, and/or the like. Cross member 10a can be configured to facilitate installation of the cross member to a vehicle; for example, beam 22 can include one or more assembly features, such as, for example, one or more openings 36, protrusions, recesses, hooks, and/or the like, from which the cross member can be lifted and/or maneuvered during assembly of the cross member to the vehicle.

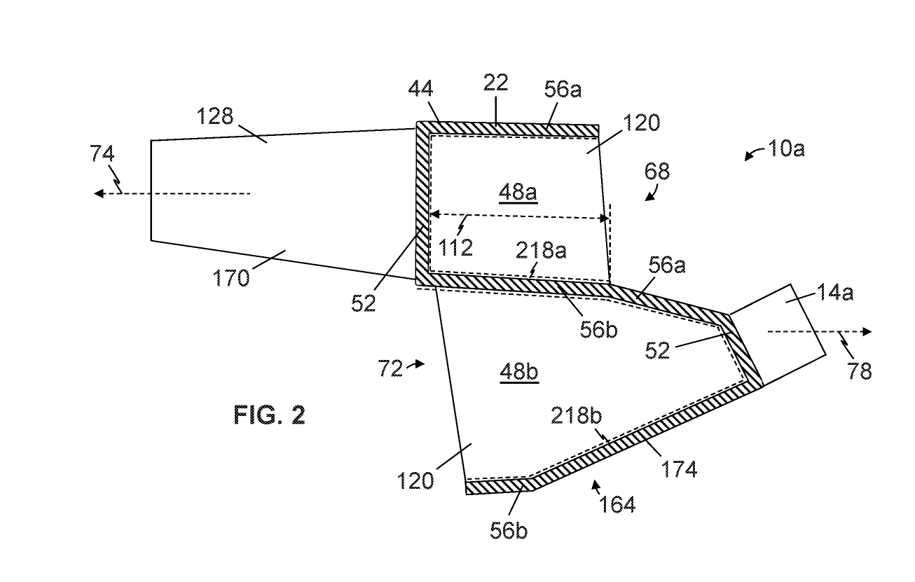

Referring additionally to FIG. 2, beam 22 can include a sidewall 44 that extends between, but not necessarily to each of, first end 26 and second end 30 to define one or more channels, each extending along a longitudinal axis 24 of the beam. For example, sidewall 44 can define a first channel 48a and/or a second channel 48b. Such channels (e.g., 48a, 48b, and/or the like) can provide reinforcement for support(s) and/or mount(s). For example, each channel (e.g., 48a, 48b, and/or the like) can include a bottom (e.g., deepest) portion 52 and opposing side portions, 56a and 56b, that extend from the bottom portion. Bottom portion 52 and/or side portions, 56a and 56b, of a channel (e.g., 48a, 48b, and/or the like) can provide a base from which a support and/or mount can extend and/or the side portions of the channel can be disposed on opposite sides of (e.g., the top and bottom of) the support and/or mount. By extending from a channel (e.g., 48a, 48b, and/or the like), a support and/or mount can extend a reduced distance from beam 22, which can stiffen the support and/or mount and/or, in molded embodiments, facilitate molding of the support and/or mount.

Such channels (e.g., 48a, 48b, and/or the like) can be open. For example, each channel (e.g., 48a, 48b, and/or the like) can have a cross-section, taken perpendicularly to a long dimension of the channel, that is open, that is U- or C-shaped, and/or the like. In molded embodiments, open channels (e.g., 48a, 48b, and/or the like) can facilitate molding of a beam (e.g., 22) by, for example, reducing undercut geometry of the beam, a number of moving mold portions (e.g., sliders) needed to mold the beam, and/or the like.

Channel 48a can be open on a first side 68 of beam 22, and channel 48b can be open on a second side 72 of the beam that is opposite the first side. In this way, open channels 48a and 48b can provide reinforcement for and/or facilitate molding of support(s) and/or mount(s) that extend from beam 22 in differing directions. For example, a portion of open channel 48a, such as bottom portion 52, can provide a base from which a first support 128 (described in more detail below) can extend in a first direction (e.g., 74), and a portion of open channel 48b, such as bottom portion 52, can provide a base from which mount 14a extends in a second direction (e.g., 78) that is opposite the first direction. Channel 48b can be disposed below channel 48a, such that, for example, at least a portion of beam 22 comprises an S-shaped cross-section. In this way, channel 48a can provide reinforcement for a first mount and/or support (e.g., first support 128, which can be a connection between beam 22 and a firewall of the vehicle), and channel 48b can provide reinforcement for a second mount and/or support (e.g., mount 14a, which can be for a steering column) that is disposed below the first mount and/or support.

Such channels (e.g., 48a, 48b, and/or the like) can be dimensioned and/or located along beam 22 pursuant to strength, stiffness, component mounting, and/or the like requirements. For example, channel 48b can be located along beam 22 such that the channel provides a mounting location (e.g., 14a) for a steering column and/or resists bending, torsion, and/or shear loads applied to the beam by the steering column. In order to reduce the weight, size, and/or cost of cross member 10a, channel 48b may not extend the full length of beam 22. Channel 48b can have a length 94 that is smaller than (e.g., less than or equal to half of) a length 86 of beam 22 and/or a length 90 of channel 48a, where the lengths are measured along longitudinal axis 24 of the beam. Channel 48b can be located along beam 22 closer to one end (e.g., 30) of the beam than to the other end (e.g., 26) of the beam. More particularly, beam 22 can include longitudinally adjacent first and second sections, 98 and 102, respectively, and channel 48b can extend across at least a majority of the second section, but not necessarily across at least a majority of the first section.

For further example, channel 48a can extend across at least a majority of beam 22 to strengthen and/or stiffen at least a majority of the beam; to illustrate, length 90 of the channel can be substantially equal to length 86 of the beam, the channel can extend across at least a majority of first section 98 and second section 102, and/or the like. A portion of channel 48a that is proximate to one end of the beam (e.g., 30), such as a portion of the channel disposed on second section 102, can have a larger height 110 and/or width 112 than a portion of the channel that is proximate to the other end of the beam (e.g., 26), such as a portion of the channel disposed on first section 98. In at least this way, channel 48a can provide for increased strength and/or stiffness of beam 22 where reinforcement of the beam may be desirable, such as, for example, where loads are applied to the beam by a steering column, where the beam is connected to a vehicle (e.g., via first support 128 and/or second support 140), and/or the like.

Beam 22 can define ribs 120 extending from sidewall 44 and into one or more channels (e.g., 48a, 48b, and/or the like) defined by the sidewall. At least some of ribs 120 within channel 48a can be substantially aligned (e.g., substantially coplanar) with at least some of ribs 120 within channel 48b, which can facilitate transfer of loads between the ribs; to illustrate, rib 120a can be aligned with rib 120b. To promote structural efficiency, at least some of ribs 120 can extend from sidewall 44 in a direction that is substantially perpendicular to the sidewall. Portions of beam 22 where reinforcement of the beam may be desirable (e.g., where loads are applied to the beam by a steering column, where the beam is connected to a vehicle, and/or the like) can have more ribs than other portions of the beam. For example, second section 102 can have more ribs 120 than first section 98. Such ribs (e.g., 120) can increase the strength and/or stiffness of a cross member (e.g., 10a) in exchange for a relatively small increase in the weight of the cross member.

Cross member 10a can comprise a first support 128 extending from second side 72 of beam 22 and configured to secure the beam to a vehicle (e.g., to a firewall of the vehicle). For example, first support 128 can define one or more openings 132 (e.g., holes, slots, recesses, and/or the like) for securing beam 22 to a vehicle, via, for example, receiving one or more fasteners that can be disposed into the vehicle. First support 128 can be located along beam 22 where reinforcement of the beam may be desirable (e.g., where loads are applied to the beam by a steering column). For example, first support 128 can be located closer to one end (e.g., 30) of beam 22 than the other end (e.g., 26) of the beam. For further example, first support 128 can extend from second section 102 of beam 22.

Cross member 10a can comprise a second support 140 extending downwardly from beam 22 and configured to secure the beam to a vehicle (e.g., to a floor and/or tunnel of the vehicle). For example, second support 140 can define one or more openings 144 (e.g., holes, slots, recesses, and/or the like) for securing beam 22 to a vehicle, via, for example, receiving one or more fasteners that can be disposed into the vehicle. As with first support 128, second support 140 can be located along beam 22 to strengthen and/or stiffen portion(s) of the beam, such as, for example, a portion of the beam where loads are applied by a steering column, a portion of the beam that is connected to a vehicle, and/or the like. For example, second support 140 can extend from channel 48b (e.g., from side portion 56b), facilitating transfer of loads between the channel and the second support. For further example, second support 140 can extend from channel 48b at an end of the channel. In at least this way, a (e.g., relatively short, when compared to length 86) portion of the beam to which loads are applied by a steering column and/or that is connected to a firewall of a vehicle, such as second section 102, can be supported on one end by the vehicle (e.g., via opening(s) 34) and on the other end by second support 140, enhancing the strength and/or stiffness of the portion of the beam.

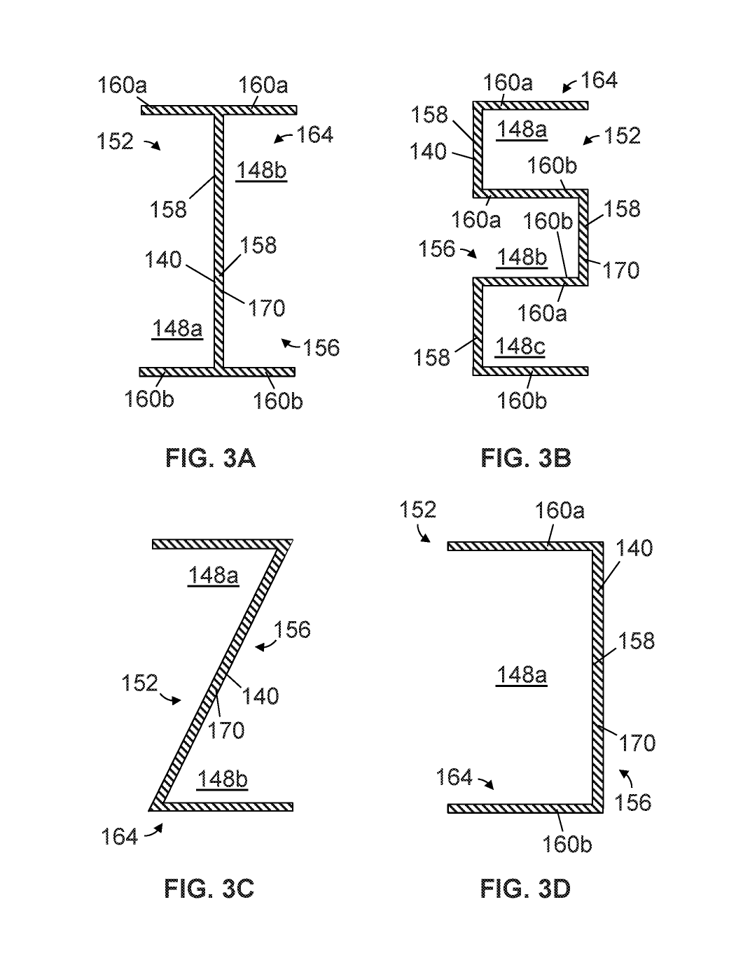

FIG. 3A is a schematic cross-sectional end view of second support 140, taken along line 3A-3A of FIG. 1A. As shown, second support 140 can define one or more channels, each extending along a longitudinal axis 142 of the second support. For example, second support 140 can define a first channel 148a and/or a second channel 148b. As described above for beam 22, second support 140 can define ribs 120 that extend into one or more channels (e.g., 148a, 148b, and/or the like) of the second support. Second support 140, via such channels (e.g., 148a, 148b, and/or the like), can resist bending, torsion, and/or the like loads, while having a relatively low weight (e.g., when compared to a channel-less structure).

Such channels (e.g., 148a, 148b, and/or the like) can be open. For example, each channel (e.g., 148a, 148b, and/or the like) can have a cross-section, taken perpendicularly to a long dimension of the channel, that is U- or C-shaped, and/or the like. In molded embodiments, open channels (e.g., 148a, 148b, and/or the like) can facilitate molding of a support (e.g., 140) by, for example, reducing undercut geometry of the support, a number of moving mold portions (e.g., sliders) needed to mold the support, and/or the like.

Channel 148a can be open on a first side 152 of second support 140, and channel 148b can be open on a second side 156 of the second support that is opposite the first side. Each channel (e.g., 148a, 148b, and/or the like) can include a bottom (e.g., deepest) portion 158 and opposing side portions, 160a and 160b, that extend from the bottom portion. In a support (e.g., 140), a bottom portion (e.g., 158) of a first channel (e.g., 148a) can abut a bottom portion (e.g., 158) of a second channel (e.g., 148b) and/or side portion(s) (e.g., 160a and/or 160b) of the first channel can be substantially co-planar with side portion(s) (e.g., 160a and/or 160b) of the second channel, such that, for example, at least a portion of the support comprises an I-shaped cross-section.

As shown in FIGS. 3B-3D, other cross members can include a support (e.g., 140) having any suitable structure, such as, for example, one in which channels (e.g., 148a, 148b, and/or the like) abut one another at respective side portion(s) (e.g., 160a and/or 160b) of the channels (e.g., FIG. 3B, in which side portions 160a and 160b of channel 148b abut side portion 160b of channel 148a and side portion 160a of channel 148c, respectively), one in which channel(s) (e.g., 148a, 148b, and/or the like) have depth(s) that vary along respective bottom portion(s) (e.g., 158) of the channel(s) (e.g., FIG. 3C, in which opposing channels 148a and 148b cooperate to define a Z-shaped cross-section of the support), one comprising a single channel (e.g., FIG. 3D), and/or the like. The cross-sections depicted in FIG. 3A-3D may each be a suitable cross-section for a beam (e.g., 22), such as, for example, a cross-section for a first section (e.g., 98) of the beam.

First support 128 and/or second support 140 can be unitary or integrally formed with beam 22. In at least this way, some cross members (e.g., 10a) can be mounted to a vehicle at one or more locations (e.g., at first support 128 and/or second support 140), without requiring separate mounting component(s) (other than fasteners), such as, for example, flange(s), mount(s), plate(s), and/or the like, which can reduce manufacturing costs, assembly time, and/or the like. In other cross members, a first support (e.g., 128) and/or a second support (e.g., 140) can comprise separate component(s) that can be coupled to (e.g., via welding, bonding, fasteners, and/or the like) a beam (e.g., 22).

Cross member 10a can comprise a composite body 164 that defines beam 22, first support 128, second support 140, and/or the like. Body 164 can be characterized as a “composite” in that the body comprises a plastic material 170 and one or more laminates 174, where the plastic material and the laminate(s) are combined to form a unitary structure. As one non-limiting example, body 164 can be formed by overmolding plastic material 170 onto one or more laminates 174.

Plastic material 170 can comprise a thermoplastic material, such as polyethyleneimine, polyetherimide, or a derivative thereof, polyethylene terephthalate, polycarbonate, polybutylene terephthalate, poly(1,4-cyclohexylidene cyclohexane-1,4-dicarboxylate), glycol-modified polycyclohexyl terephthalate, poly(phenylene oxide), polypropylene, polyethylene, polyvinyl chloride, polystyrene, polymethyl methacrylate, thermoplastic elastomer, terephthalic acid elastomer, poly(cyclohexanedimethylene terephthalate), polyethylene naphthalate, polyamide (e.g., PA6, PA66, and/or the like), polysulfone sulfonate, polyether ether ketone, polyether ketone ketone, acrylonitrile butyldiene styrene, polyphenylene sulfide, polycarbonate/polybutylene succinate, a co-polymer thereof, or a combination thereof, or a thermoset material, such as unsaturated polyester resin, polyurethane, bakelite, duroplast, urea-formaldehyde, diallyl-phthalate, epoxy resin, epoxy vinylester, polyimide, cyanate ester of polycyanurate, dicyclopentadiene, benzoxazine, a co-polymer thereof, or a combination thereof. Plastic material 170 can include dispersed elements, such as, for example, discontinuous or short fibers (e.g., carbon fibers, glass fibers, basalt fibers, aramid fibers, polyethylene fibers, polyester fibers, polyamide fibers, steel fibers, textile fibers, or a combination thereof), which can account for 10 to 70% of the plastic material by weight.

One or more laminates (e.g., 174) can each include any suitable number of laminae (e.g., 1, 2, 3, 4, 5, 6, 7, 8, 9, 10, or more laminae), each having fibers (e.g., 186) dispersed within a matrix material (e.g., 190). For example, a lamina can comprise from 30 to 70% fibers (e.g., 186) by volume and/or from 10 to 85% fibers by weight. A matrix material (e.g., 190) of a lamina can include any suitable matrix material, such as, for example, one or more of the thermoplastic materials described above and/or one or more of the thermoset materials described above. A matrix material (e.g., 190) of a lamina and a plastic material (e.g., 170) can include a same material, which can facilitate a bond between the plastic material and the lamina.

Fibers (e.g., 186) of a lamina can include any suitable fibers, such as, for example, any of the fibers described above. Fibers (e.g., 186) of a lamina can be arranged and/or structured in any suitable fashion. For example, fibers (e.g., 186) of a lamina can be continuous and/or discontinuous. For further example, fibers (e.g., 186) of a lamina can include yarns, which, in turn, can comprise braided and/or commingled strands, and such a yarn can include strands of a first material (e.g., a polymeric material) and strands of a second material (e.g., a non-polymeric material) that is different than the first material. For yet further example, fibers (e.g., 186) of a lamina can be oriented relative to one another such that substantially all of the fibers are substantially parallel to one another (e.g., as in a lamina formed from a unidirectional fiber tape), such that the fibers define a woven structure (e.g., as in a lamina having a plane, twill, satin, basket, leno, mock leno, or the like weave, whether two- or three-dimensional), or the like.

As will be described in more detail below, laminate(s) (e.g., 174) can be disposed along a structure (e.g., beam 22, first support 128, second support 140, and/or the like) to increase the strength and/or stiffness of the structure. To illustrate, for a given laminate (e.g., 174) disposed along a structure (e.g., beam 22, first support 128, second support 140, and/or the like), fibers (e.g., 186) that are substantially aligned with a long dimension and/or longitudinal axis of the structure can resist bending of the structure, and fibers that are angularly disposed relative to the long dimension and/or longitudinal axis of the structure can resist torsion of the structure.

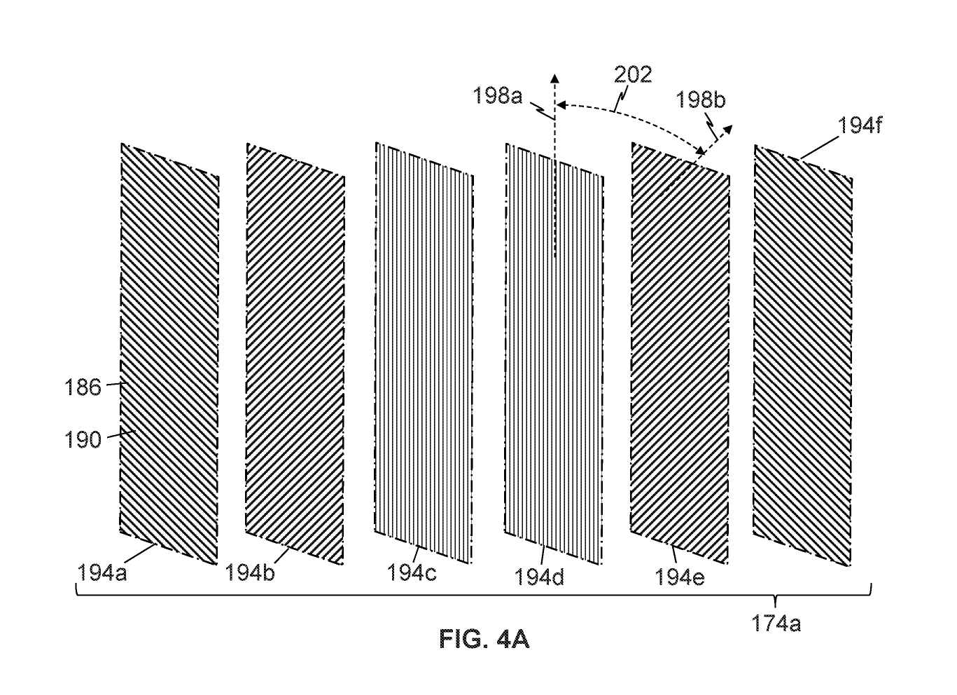

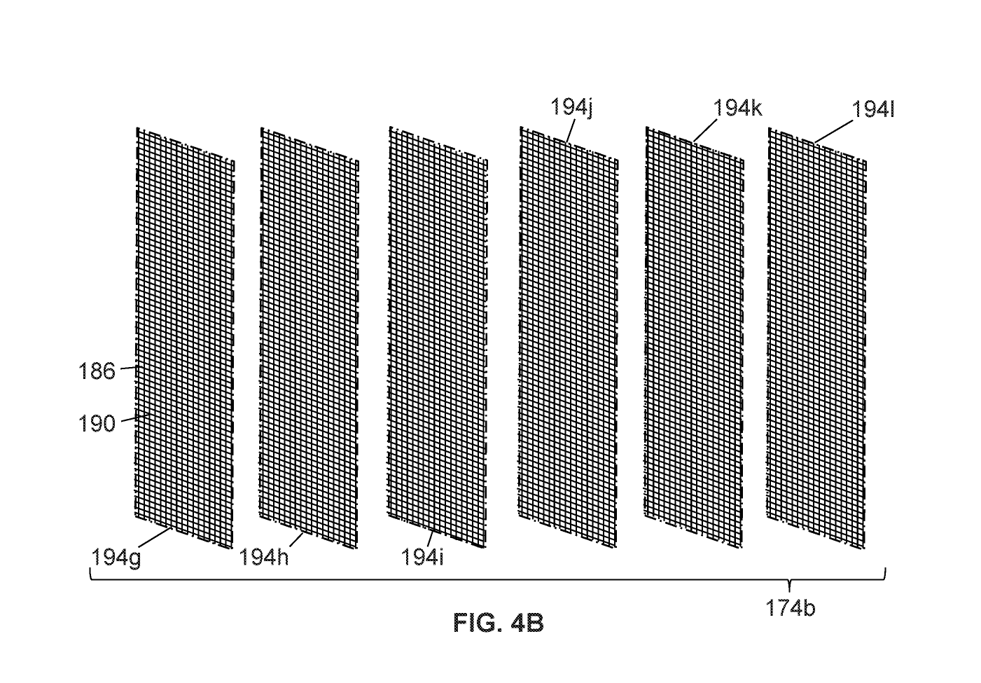

FIG. 4A depicts a schematic exploded view of a laminate 174a that may be suitable for use in some cross members (e.g., 10a). Laminate 174a can include a lamina 194d in which substantially all of fibers 186 are substantially parallel to one another (e.g., the lamina can be formed from a unidirectional fiber tape). Fibers 186 of lamina 194d can be aligned in a first direction 198a, and laminate 174a can include a lamina 194e having fibers 186 aligned in a second direction 198b that is angularly disposed relative to the first direction. For example, a smallest angle 202 between first direction 198a and second direction 198b can be approximately 5, 10, 15, 20, 25, 30, 35, 40, 45, 50, 55, 60, 65, 70, 75, 80, 85, or 90 degrees. More particularly, laminate 174a can include six (6) laminae, 194a-194f, each having fibers 186 that are angularly disposed at approximately 45, −45, 0, 0, −45, and 45 degrees, respectively, relative to a long dimension and/or longitudinal axis of the lamina, the laminate, and/or a structure (e.g., beam 22, first support 128, second support 140, and/or the like) along which the laminate is disposed. Placing 0 degree lamina(e) (e.g., 194c, 194d, and/or the like) of a laminate (e.g., 174a) between other, non-0 degree laminae (e.g., 194a, 194b, 194e, 194f, and/or the like) of the laminate can mitigate undesirable fiber (e.g., 186) movement (e.g., fiber splitting) within the 0 degree lamina(e), which can occur, for example, during overmolding. Other laminate(s) (e.g., 174) can each include lamina(e) having fibers that are angularly disposed at any suitable angle relative to a long dimension and/or longitudinal axis of the lamina, the laminate, and/or a structure (e.g., beam 22, first support 128, second support 140, and/or the like) along which the laminate is disposed, such as, for example, approximately −90, −85, −80, −75, −70, −65, −60, −55, −50, −45, −40, −35, −30, −25, −20, −15, −10, −5, 0, 5, 10, 15, 20, 25, 30, 35, 40, 45, 50, 55, 60, 65, 70, 75, 80, 85, and/or 90 degrees. Laminae of a laminate (e.g., 174) can be stacked in a symmetric (e.g., FIG. 4A) or asymmetric configuration.

FIG. 4B depicts a schematic exploded view of a laminate 174b that may be suitable for use in some cross members (e.g., 10a). Laminate 174b can include a lamina 194g having fibers 186 that define a woven structure. For example, lamina 194g can include a first set of fibers 186 that are substantially aligned with one another and a second set of fibers 186 that are substantially aligned with one another, where the second set of fibers is woven with and angularly disposed relative to the first set of fibers. More particularly, lamina 194g of laminate 174b can be a 0/90 lamina in which the second set of fibers is angularly disposed relative to the first set of fibers at an angle of approximately 90 degrees. Laminate 174b can include six (6) laminae, 194g-194l, each of which can be a 0/90 lamina; however, other laminates (e.g., 174) can include 0/90, +30/−60, −30/+60, +45/−45, and/or the like woven lamina(e) (e.g., as well as non-woven lamina(e)).

One or more laminates 174 of cross member 10a can be dimensioned and/or located on and/or within the cross member pursuant to strength, stiffness, component mounting, and/or the like requirements. For example, one or more of laminate(s) 174 can be disposed along beam 22 to, for example, increase the strength and/or stiffness of the beam where loads are applied to the beam (e.g., by a steering column), where the beam is mounted to a vehicle (e.g., via first support 128, second support 140, and/or the like), and/or the like. One or more of laminate(s) 174 disposed along beam 22 can have fibers (e.g., 186) that are substantially aligned with longitudinal axis 24 of the beam and/or fibers (e.g., 186) that are angularly disposed relative to the longitudinal axis of the beam (e.g., at an angle of approximately 15, 30, 45, 60, 75, and/or 90 degrees).

More particularly, as shown in FIG. 2, one or more of laminate(s) 174 can be disposed along beam 22 such that the laminate(s) border at least a portion of (e.g., at least a majority of) an inner cross-sectional perimeter 218a of channel 48a. Similarly, one or more of laminate(s) 174 can be disposed along beam 22 such that the laminate(s) border at least a portion of (e.g., at least a majority of) an inner cross-sectional perimeter 218b of channel 48b. In other words, one or more of laminate(s) 174 can underlie, overlie, define, and/or be disposed within sidewall 44 at bottom portion 52 and/or opposing side portions 56a and/or 56b of channels 48a and/or 48b. At least a single one of laminate(s) 174 can border at least a portion of (e.g., at least a majority of) inner cross-sectional perimeter 218a of channel 48a and at least a portion of (e.g., at least a majority of) inner cross-sectional perimeter 218b of channel 48b. In these ways and others, one or more of laminate(s) 174 can provide reinforcement for support(s) and/or mount(s) (e.g., first support 128, second support 140, mount 14a, and/or the like), via, for example, strengthening and/or stiffening portion(s) of beam 22 where the support(s) and/or mount(s) are located, being disposed on opposite sides of (e.g., the top and the bottom of) the support(s) and/or mount(s), and/or the like.

One or more laminates 174 that are disposed along beam 22 may not extend the entire length 86 of beam 22. For example, one or more laminates 174 that are disposed along beam 22 can span a total distance 216 along the beam, measured along longitudinal axis 24 of the beam, that is smaller than (e.g., less than or equal to half of) length 86 of the beam. For further example, one or more laminates 174 that are disposed along beam 22 can be disposed closer to one end (e.g., 30) of the beam than to the other end (e.g., 26) of the beam (e.g., the laminate(s) can extend across at least a majority of second section 102, but not necessarily across at least a majority of first section 98). In general, plastic material (e.g., 170) may be less expensive than laminate(s) 174; thus, such cross members (e.g., 10a) can provide for reduced manufacturing costs without undesirably compromising the strength and/or stiffness of the cross members, as illustrated in the examples below. In some cross members, laminate(s) (e.g., 174) can be disposed along a beam (e.g., 22) such that one or more openings (e.g., 34) of the beam for securing the beam to a vehicle extend through the laminate(s), thereby increasing the strength and/or stiffness of the beam at a mounting location of the beam to a vehicle.

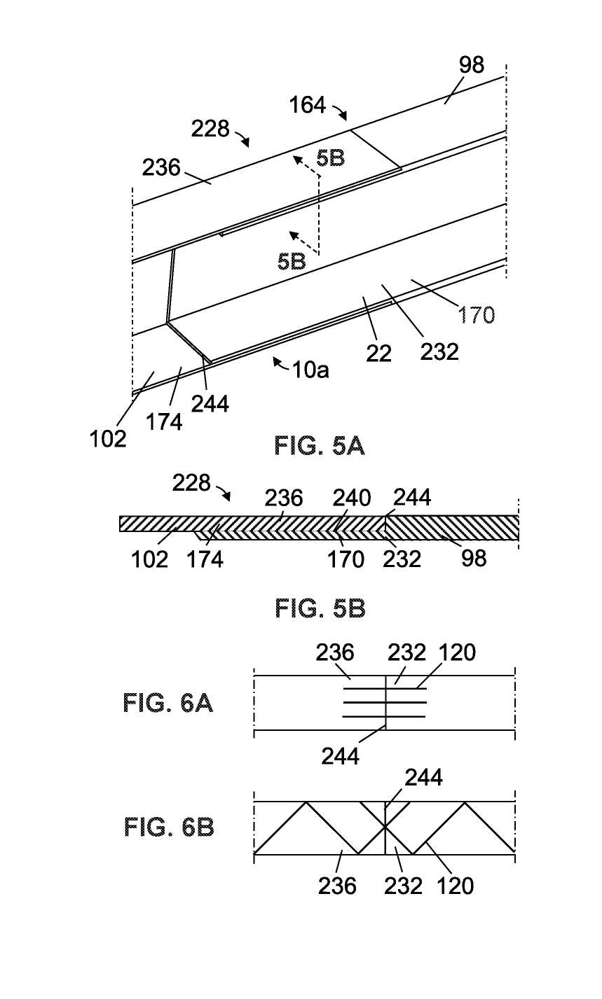

Referring additionally to FIGS. 5A and 5B, shown is a joint 228 that may be suitable for use between adjacent sections (e.g., first section 98 and second section 102) of a cross member (e.g., 10a) and/or between a plastic material (e.g., 170) and one or more laminates (e.g., 174). Joint 228 can be characterized as a lap joint; for example, at the joint, a first section (e.g., 98) can be joined to a second section (e.g., 102) such that a portion 232 of the first section overlies and/or underlies a portion 236 of the second section. At least one of portion 232 and portion 236 can include a recess 240 within which the other portion is disposed, which can increase the surface area of the interface between the portions, provide for a smooth transition between the portions, and/or the like. One of portions 232 and 236 can be substantially comprised of (by weight and/or volume) or consist of plastic material 170, and the other of the portions can be substantially comprised of (by weight and/or volume) or consist of laminate(s) 174. As shown in FIGS. 6A and 6B, joint 228 can be reinforced with ribs 120 that extend across a seam 244 between portions 232 and 236, each of which can extend in a direction that is substantially perpendicular to the seam (FIG. 6A) or in a direction that is angularly disposed relative to the seam (FIG. 6B). In these ways and others, joint 228 can facilitate connection of and/or load transfer between adjacent sections (e.g., first section 98 and second section 102) of a cross member (e.g., 10a) and/or a plastic material (e.g., 170) and one or more laminates (e.g., 174).

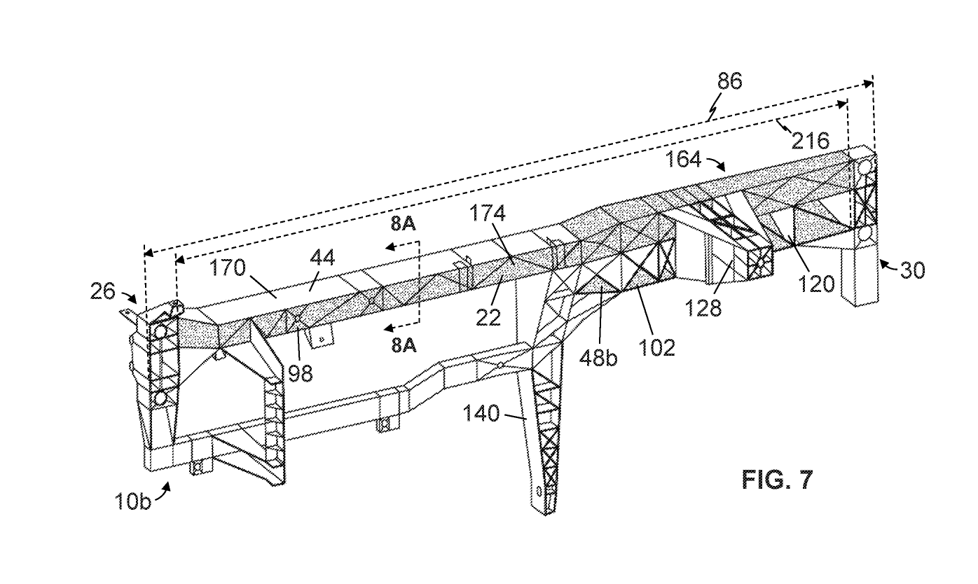

Referring now to FIG. 7, shown is a second embodiment 10b of the present vehicle cross members. Cross member 10b can be substantially similar to cross member 10a, with the primary exceptions described below. In cross member 10b, one or more laminates 174 that are disposed along beam 22 can span a total distance 216 along the beam, measured along longitudinal axis 24 of the beam, that is greater than or equal to half of length 86 of the beam. For example, distance 216 can be substantially equal to length 86, one or more laminates 174 that are disposed along beam 22 can extend across at least a majority of first section 98 and second section 102, and/or the like.

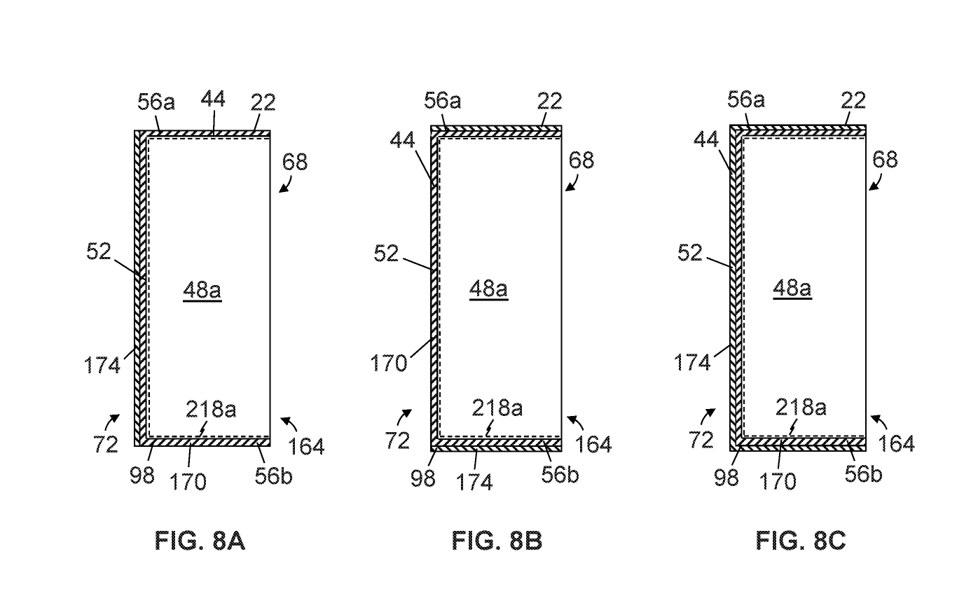

Similarly to as described above for cross member 10a, in cross member 10b, one or more of laminate(s) 174 can be disposed along beam 22 (e.g., first section 98 thereof) such that the laminate(s) border at least a portion of (e.g., at least a majority of) inner cross-sectional perimeter 218a of channel 48a (FIGS. 8A-8C). In other words, one or more of laminate(s) 174 can underlie, overlie, define, and/or be disposed within sidewall 44 at bottom portion 52 (FIGS. 8A and 8C) and/or opposing side portions 56a and/or 56b (FIGS. 8B and 8C) of channel 48a. In these ways and others, one or more laminates 174 of cross member 10b can facilitate the cross member in resisting high-impact (e.g., crash-related) loads.

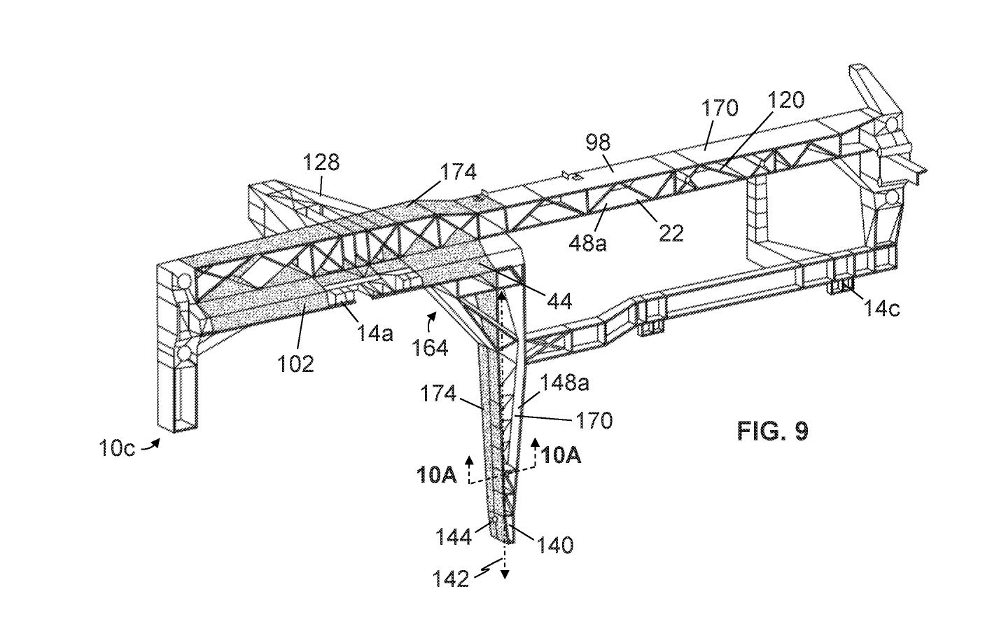

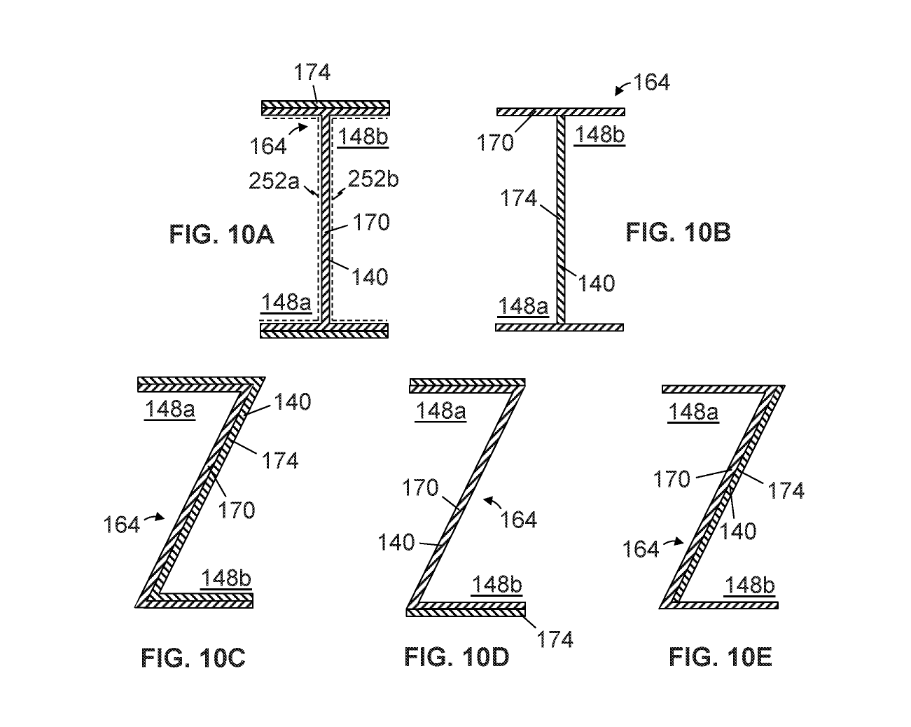

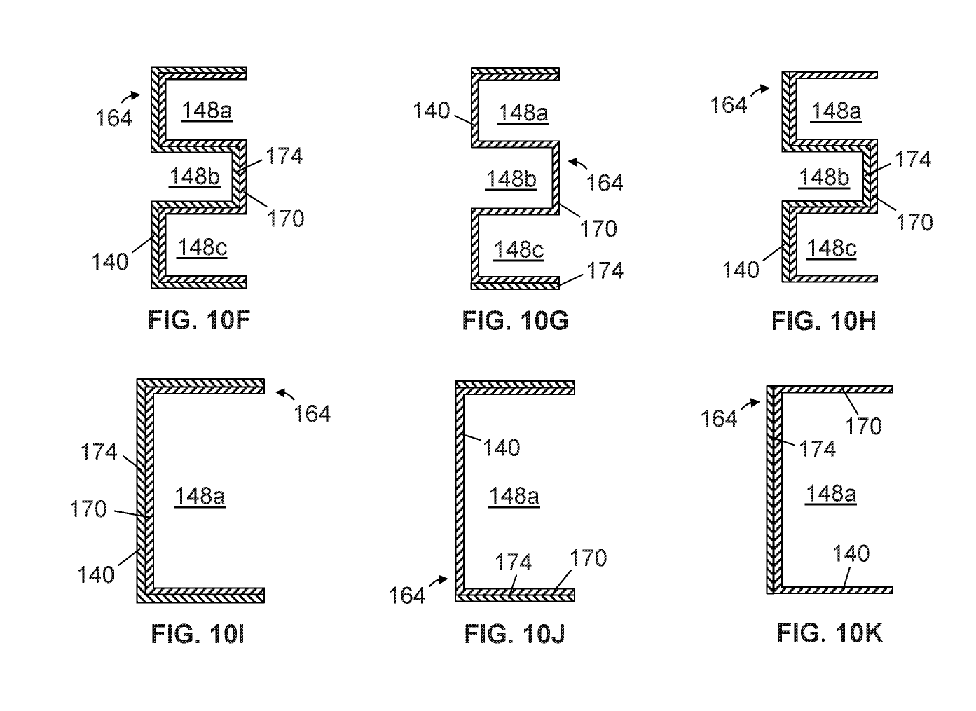

Referring now to FIG. 9, shown is a third embodiment 10c of the present vehicle cross members. Cross member 10c can be substantially similar to cross member 10a, with the primary exceptions described below. In cross member 10c, one or more of laminate(s) 174 can be disposed along second support 140 to, for example, increase the strength and/or stiffness of the second support, facilitate load transfer between beam 22 and the second support, and/or the like. One or more of laminate(s) 174 disposed along second support 140 can have fibers (e.g., 186) that are substantially aligned with longitudinal axis 142 of the second support and/or fibers (e.g., 186) that are angularly disposed relative to the longitudinal axis of the second support (e.g., at an angle of approximately 15, 30, 45, 60, 75, and/or 90 degrees). More particularly, as shown in FIGS. 10A-10K, one or more of laminate(s) (e.g., 174) can be disposed along a second support (e.g., 140) such that the laminate(s) border at least a portion of (e.g., at least a majority of) an inner cross-sectional perimeter (e.g., 252a, 252b, and/or the like) of each of one or more of channel(s) (e.g., 148a, 148b, 148c, and/or the like) of the second support. The cross-sections depicted in FIGS. 10A-10K may each be a suitable cross-section for a beam (e.g., 22), such as, for example, a cross-section for a first section (e.g., 98) of the beam.

One or more of laminate(s) 174 can be disposed along second support 140 such that one or more openings 144 of the second support for securing the second support to a vehicle extend through the laminate(s), thereby increasing the strength and/or stiffness of the second support at a mounting location of the second support to a vehicle. In some cross members, at least a single one of laminate(s) (e.g., 174) can be disposed along a beam (e.g., 22) and along a second support (e.g., 140).

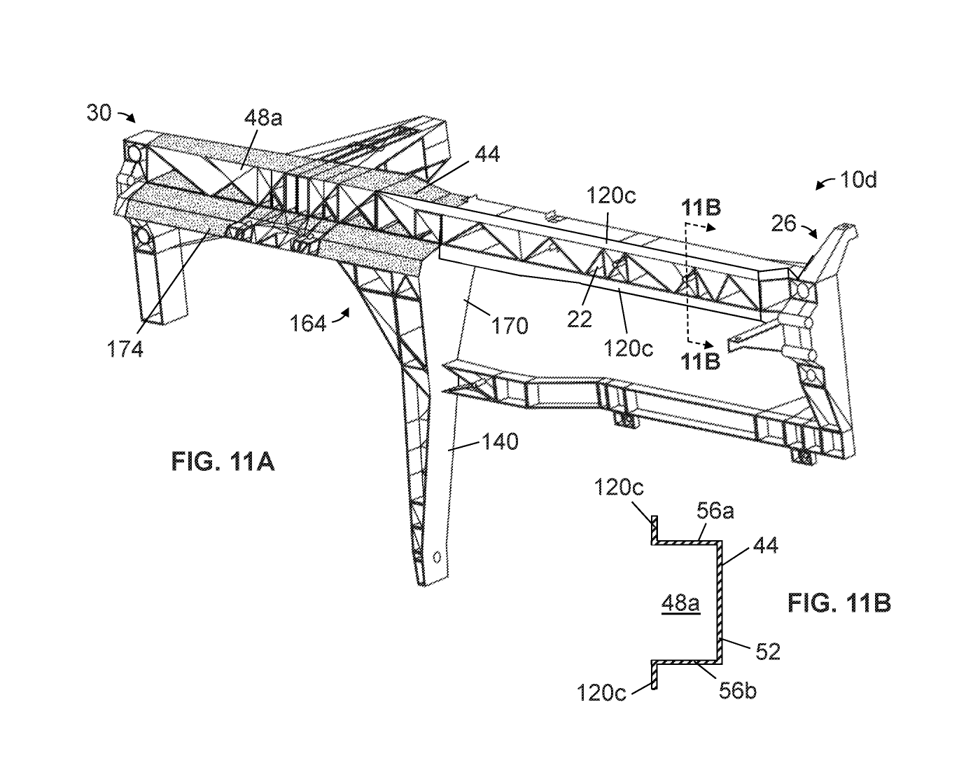

Referring now to FIGS. 11A and 11B, shown is a fourth embodiment 10d of the present cross members. Cross member 10d can be substantially similar to cross member 10a, with the primary exceptions described below. Cross member 10d can include one or more ribs 120c that extend from sidewall 44 and away from one or more channels (e.g., 48a, 48b, and/or the like). For example, cross member 10d can include rib(s) 120c that extend from side portion(s) 56a and/or 56b of channel 48a and away from the channel (FIG. 11B). Rib(s) 120 can extend from side portion(s) 56a and/or 56b at an end of the side portion(s) that is opposite bottom portion 52. In some cross members (e.g., 10d), one or more of laminate(s) (e.g., 174) can underlie, overlie, define, and/or be disposed within rib(s) (e.g., 120c). Ribs(s) 120c can stiffen beam 22 and can resist buckling of the beam when the beam is subjected to side loads. Such rib(s) (e.g., 120c) can be present in other embodiments (e.g., 10a, 10b, 10c, and/or the like) of the present cross members.

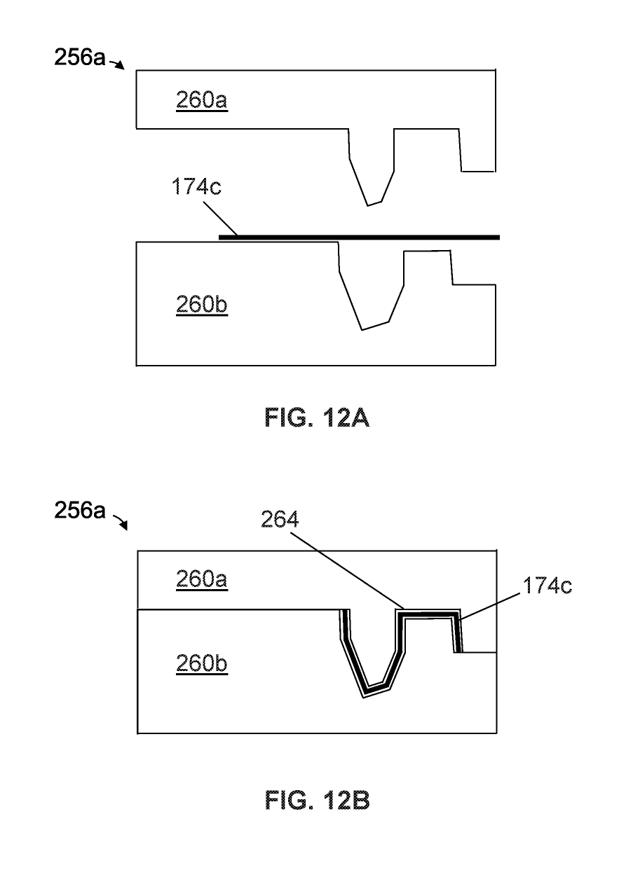

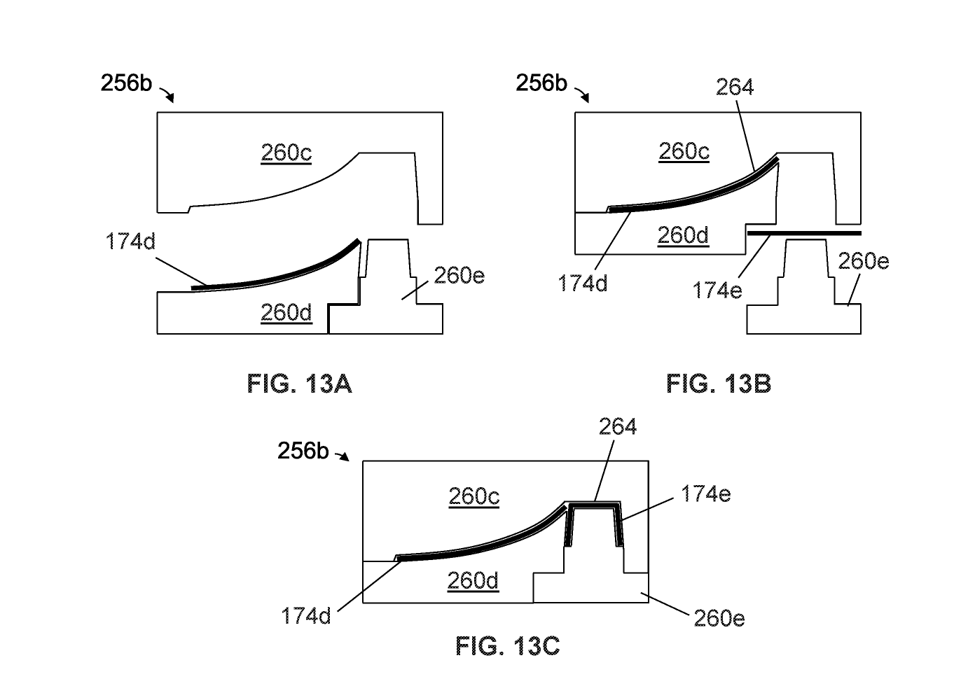

Referring now to FIGS. 12A and 12B and 13A-13C, shown are molds, 256a and 256b, respectively, that may each be suitable for forming a composite body (e.g., 164) of some embodiments of the present vehicle cross-members (e.g., 10a, 10b, 10c, 10d, and/or the like). As shown in FIGS. 12A and 12B, mold 256a can include two or more mold portions, 260a and 260b, configured to position a laminate 174c within a mold cavity 264 of the mold. Once laminate 174c is positioned within mold cavity 264, plastic material (e.g., 170) can be injected into the mold cavity to form a composite body (e.g., 164). Such injection can be performed via any suitable number of injection gate(s), which can be opened simultaneously and/or sequentially.

Additional mold portion(s) or slider(s) can be used to facilitate forming a composite body (e.g., 164), depending on, for example, the number and/or relative orientation(s) of laminate(s) (e.g., 174) of the composite body. For example, as shown in FIGS. 13A-13C, mold 256b can include two or more mold portions, 260c and 260d, configured to position a laminate 174d within a mold cavity 264 of the mold. Mold 256b can include an additional mold portion or slider 260e configured to position a laminate 174e within mold cavity 264. Laminate 174d can extend in a first direction (e.g., to ultimately define at least a portion of a second support 140), and laminate 174e can extend in a second direction that is angularly disposed relative to the first direction (e.g., to ultimately define at least a portion of a beam 22). Once laminates 174d and 174e are positioned within mold cavity 264, plastic material (e.g., 170) can be injected into the mold cavity to form a composite body (e.g., 164).

Some embodiments of the present methods for forming a vehicle cross member (e.g., 10a, 10b, 10c, 10d, and/or the like) comprise forming, in a mold, a composite body (e.g., 164) including a plastic material (e.g., 170) and one or more laminates (e.g., 174), each having fibers (e.g., 186) dispersed within a matrix material (e.g., 190). In some methods, forming, in the mold, the body comprises forming the one or more laminates in the mold. For example, in some methods, forming the one or more laminates in the mold comprises placing one or more layers of material, each comprising an arrangement of fibers, into the mold and overmolding the plastic material onto the one or more layers of material (e.g., thereby introducing the plastic material into the arrangement(s) of fibers to form the one or more laminates). Some methods comprise placing the one or more (e.g., at least partially pre-formed) laminates into the mold and overmolding the plastic material onto the one or more laminates. In some methods, the one or more laminates are at least partially consolidated (e.g., heated and/or compressed) before the one or more laminates are placed into the mold.

### Examples

Structural analysis software was used to compare structural characteristics of cross member 10a with those of a comparable metal cross beam. In this instance, cross member 10a includes a laminate (e.g., 174) having glass fibers (e.g., 186) dispersed within a polypropylene matrix material (e.g., 190). The laminate comprises approximately 45% fibers by volume. The laminate has a layup of 10 laminae, each having fibers that are angularly disposed at 45, −45, 0, 0, 0, 0, 0, 0, −45, and 45 degrees, respectively, relative to longitudinal axis 24 of beam 22. In this instance, cross member 10a includes a plastic material (e.g., 170) comprising long glass fiber-filled polypropylene, having 40% fibers by weight.

To illustrate, modal frequencies and deflections under various loads for cross member 10a and the comparable metal car cross beam are shown in the tables below.

TABLE 1
Modal Frequencies of one Embodiment of the Present Vehicle Cross
Members and a Comparable Metal Car Cross Beam

| | | Comparable Metal Car Cross |
|---|---|---|
| Mode | Cross Member 10a (Hz) | Beam (Hz) |
| 1 | 41.5 | 41.3 |
| 2 | 42.1 | 42.3 |

TABLE 2
Deflections under Various Loads for one Embodiment of the Present
Vehicle Cross Members and a Comparable Metal Car Cross Beam

| | | Cross | Comparable Metal |
|---|---|---|---|
| | | Member 10a | Car Cross Beam |
| Load Description | Load (N) | (mm) | (mm) |
| Steering Wheel | 1000 | 2.55 | 2.548 |
| (Vertical) | | | |
| Steering Wheel | 1000 | 2.82 | 2.843 |
| (Horizontal) | | | |
| Gravity | Weight of | 1.21 | 1.54 |
| | Cross Member | | |
| Passenger Airbag | 1000 | 2.416 | 2.416 |
| Glove Box | 50 | 1.092 | 1.093 |

Despite being approximately 30% lighter than the comparable metal car cross beam, as shown, structural performance of cross member 10a is substantially similar to the comparable metal car cross beam. In addition, the comparable metal car cross beam requires the assembly of a significant number of separate components (e.g., approximately 20) when compared to cross member 10a, which can be largely or wholly formed in a mold as a unitary body 164 (e.g., including mount(s) 14a, 14b, 14c, and/or the like, support(s) 128, 140, and/or the like, and/or the like); thus, cross member 10a may provide for reduced assembly time and/or cost.

Some embodiments of the present vehicle cross members comprise: an elongated beam having a first end, a second end, and a sidewall extending between the first and second ends to define a first channel extending along a longitudinal axis of the beam and across at least longitudinally adjacent first and second sections of the beam, the first channel being open on a first side of the beam, and a second channel extending along the longitudinal axis and across at least the second section, the second channel being disposed below the first channel and open on a second side of the beam that is opposite the first side.

Some cross members comprise a car cross beam. In some cross members, at least one of the first end and the second end of the beam defines one or more openings into the beam for securing the beam to a vehicle. Some cross members comprise one or more mounts, each configured to couple a component to the beam, wherein the component is selected from the group consisting of: a steering column, an airbag housing or carrier, and an instrument cluster.

In some cross members, the first channel extends a first length along the longitudinal axis of the beam, the second channel extends a second length along the longitudinal axis, and the second length is less than or equal to half of the first length. Some cross members comprise one or more ribs extending into the first and second channels.

Some cross members comprise a composite body including a plastic material and one or more laminates, each having fibers dispersed within a matrix material, wherein the body defines the beam. In some cross members, the plastic material comprises a thermoplastic material, a thermoset material, or a combination thereof. In some cross members, for at least one of the one or more laminates, the fibers comprise carbon fibers, glass fibers, basalt fibers, textile fibers, or a combination thereof. In some cross members, for at least one of the one or more laminates, the matrix material comprises a thermoplastic material, a thermoset material, or a combination thereof. In some cross members, for at least one of the one or more laminates, the matrix material comprises the plastic material.

In some cross members, at least one of the one or more laminates is disposed along the beam such that the at least one laminate borders at least a portion of (e.g., at least a majority of) an inner cross-sectional perimeter of each of the first and second channels. In some cross members, the laminate(s) disposed along the beam span a total distance along the beam measured along the longitudinal axis of the beam that is less than or equal to half of a length of the beam measured along the longitudinal axis. In some cross members, the laminate(s) disposed along the beam span a total distance along the beam measured along the longitudinal axis of the beam that is greater than half of a length of the beam measured along the longitudinal axis.

Some cross members comprise a first support (e.g., defined by the body) extending from the second side of the beam, the first support configured to secure the beam to a vehicle. In some cross members, the first support extends from the second section of the beam.

Some cross members comprise a second support (e.g., defined by the body) extending downwardly from the beam, the second support configured to secure the beam to a vehicle. In some cross members, the second support extends from the second section of the beam. In some cross members, the second support defines one or more openings for securing the second support to a vehicle. In some cross members, at least one of the one or more openings extends through at least one of the one or more laminates.

In some cross members, the second support defines a third channel extending along a longitudinal axis of the second support. In some cross members, the second support defines a fourth channel extending along the longitudinal axis of the second support, the third channel is open on a first side of the second support, and the fourth channel is open on a second side of the second support that is opposite the first side. In some cross members, at least one of the one or more laminates is disposed along the second support such that the at least one laminate borders at least a portion of (e.g., at least a majority of) an inner cross-sectional perimeter of the third channel. In some cross members, at least one of the one or more laminates is disposed along the second support such that the at least one laminate borders at least a portion of (e.g., at least a majority of) an inner cross-sectional perimeter of the fourth channel.

Some of the present methods for forming a vehicle cross member comprise forming, in a mold, the composite body of any of the present vehicle cross members. In some methods, forming, in the mold, the body comprises forming the one or more laminates in the mold. In some methods, forming the one or more laminates in the mold comprises placing one or more layers of material, each comprising an arrangement fibers, into the mold and overmolding the plastic material onto the one or more layers of material. Some methods comprise placing the one or more laminates into the mold and overmolding the plastic material onto the one or more laminates.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A vehicle cross member comprising:
an elongated beam having:
a first end;
a second end; and
a sidewall extending between the first and second ends to define:
a first channel extending a first length along a longitudinal axis of the beam and across at least longitudinally adjacent first and second sections of the beam, the first channel being open on a first side of the beam and having:
a bottom portion; and
first and second opposing side portions extending from the bottom portion and toward the first side; and
a second channel extending a second length along the longitudinal axis and across at least the second section, the second channel being open on a second side of the beam that is opposite the first side and having:
a bottom portion; and
first and second opposing side portions extending from the bottom portion of the second channel and toward the second side;
wherein the second channel is disposed below the first channel such that:
at least a portion of one of the first and second side portions of the first channel is defined by a segment of the sidewall;
at least a portion of one of the first and second side portions of the second channel is defined by the segment of the sidewall; and
a line that is perpendicular to the longitudinal axis extends through the opposing side portions of each of the first and second channels;
wherein the second length is less than or equal to half of the first length.

2. The vehicle cross member of claim 1, comprising one or mounts, each configured to couple a component to the beam, wherein the component is selected from the group consisting of: a steering column, an airbag housing or carrier, and an instrument cluster.

3. A vehicle cross member comprising:
an elongated beam having:
a first end;
a second end; and
a sidewall extending between the first and second ends to define:
a first channel extending along a longitudinal axis of the beam and across at least longitudinally adjacent first and second sections of the beam, the first channel being open on a first side of the beam and having:
a bottom portion; and
first and second opposing side portions extending from the bottom portion and toward the first side; and
a second channel extending along the longitudinal axis and across at least the second section, the second channel being open on a second side of the beam that is opposite the first side and having:
a bottom portion; and
first and second opposing side portions extending from the bottom portion of the second channel and toward the second side;
wherein the second channel is disposed below the first channel such that:
at least a portion of one of the first and second side portions of the first channel is defined by a segment of the sidewall;
at least a portion of one of the first and second side portions of the second channel is defined by the segment of the sidewall; and
a line that is perpendicular to the longitudinal axis extends through the opposing side portions of each of the first and second channels;
one or more mounts, each configured to couple a component to the beam, wherein the component is selected from the group consisting of: a steering column, an airbag housing or carrier, and an instrument cluster.

4. The vehicle cross member of claim 3, wherein:
the first channel extends a first length along the longitudinal axis of the beam;
the second channel extends a second length along the longitudinal axis; and
the second length is less than or equal to half of the first length.

5. The vehicle cross member of claim 3, comprising a first support extending from the second side of the beam, the first support configured to secure the beam to a vehicle.

6. The vehicle cross member of claim 3, comprising a second support extending downwardly from the beam, the second support configured to secure the beam to a vehicle.

7. The vehicle cross member of claim 6, wherein at least one of the first support and the second support extends from the second section of the beam.

8. The vehicle cross member of claim 3, comprising:
a composite body including:
a plastic material; and
one or more laminates, each having fibers dispersed within a matrix material;
wherein the body defines the beam; and
wherein at least one of the one or more laminates is disposed along the beam such that the at least one laminate borders at least a portion of an inner cross-sectional perimeter of each of the first and second channels.

9. The vehicle cross member of claim 8, wherein at least one of the one or more laminates is disposed along the beam such that the at least one laminate borders a majority of an inner cross-sectional perimeter of each of the first and second channels.

10. A vehicle cross member comprising:
a composite body including:
a plastic material; and
one or more laminates, each having fibers dispersed within a matrix material;
wherein the body defines an elongated beam comprising:
a first end;
a second end; and
a sidewall extending between the first and second ends to define:
a first channel extending along a longitudinal axis of the beam and across at least longitudinally adjacent first and second sections of the beam, the first channel being open on a first side of the beam; and
a second channel extending along the longitudinal axis and across at least the second section, the second channel being disposed below the first channel and open on a second side of the beam that is opposite the first side;
wherein at least one of the one or more laminates is disposed along the beam such that the at least one laminate borders a majority of an inner cross-sectional perimeter of each of the first and second channels.

11. The vehicle cross member of claim 10, wherein the laminate(s) disposed along the beam span a total distance along the beam measured along the longitudinal axis of the beam that is less than or equal to half of a length of the beam measured along the longitudinal axis.

12. The vehicle cross member of claim 10, wherein the laminate(s) disposed along the beam span a total distance along the beam measured along the longitudinal axis of the beam that is greater than half of a length of the beam measured along the longitudinal axis.

13. The vehicle cross member of claim 10, wherein the body defines a first support extending from the second side of the beam, the first support configured to secure the beam to a vehicle.

14. The vehicle cross member of claim 10, wherein the body defines a second support extending downwardly from the beam, the second support configured to secure the beam to a vehicle.

15. The vehicle cross member of claim 10, wherein the plastic material comprises a thermoplastic material, a thermoset material, or a combination thereof.

16. The vehicle cross member of claim 10, wherein, for at least one of the one or more laminates, the fibers comprise carbon fibers, glass fibers, basalt fibers, textile fibers, or a combination thereof.

17. The vehicle cross member of claim 10, wherein, for at least one of the one or more laminates, the matrix material comprises a thermoplastic material, a thermoset material, or a combination thereof.

18. The vehicle cross member of claim 10, wherein, for at least one of the one or more laminates, the matrix material comprises the plastic material.

19. The vehicle cross member of claim 3, comprising one or more ribs extending into the first and second channels.

20. A method for forming a vehicle cross member, the method comprising:
forming, in a mold, the composite body of claim 10.
